(19) United States
(12) Patent Application Publication
(10) Pub. No.: US 2019/0251268 A1
(43) Pub. Date: Aug. 15, 2019

(54) REVERSIBLE DNA INFORMATION HIDING METHOD BASED ON PREDICTION-ERROR EXPANSION AND HISTROGRAM SHIFTING

(71) Applicant: Tongmyong University Industry-Academy Cooperation Foundation, Busan (KR)

(72) Inventors: Sukhwan Lee, Gimhae (KR); Eungju Lee, Busan (KR); Dong Yeop Lee, Busan (KR); Ju Hyeon Jeong, Busan (KR)

(21) Appl. No.: 15/905,121

(22) Filed: Feb. 26, 2018

(30) Foreign Application Priority Data
Feb. 13, 2018 (KR) 10-2018-017337

(51) Int. Cl. G06F 21/60; G06F 19/28; G06N 3/12

(52) U.S. Cl. CPC G06F 21/60; G06N 3/123; G06F 19/28

(57) ABSTRACT

Disclosed is a reversible DNA information hiding method based on prediction-error expansion and histogram shifting, the method being capable of false start codon prevention, original sequence length preservation, high watermark capacity, and blind detection based on prediction-error expansion and histogram shifting without biological mutation.

### CROSS REFERENCE TO RELATED APPLICATION

The present application claims priority to Korean Patent Application No. 10-2018-017337, filed Feb. 13, 2018, which is incorporated herein by reference.

### TECHNICAL FIELD

The present invention relates generally to a reversible DNA information hiding method based on prediction-error expansion and histogram shifting, the method being capable of false start codon prevention, original sequence length preservation, high watermark capacity, and blind detection based on prediction-error expansion and histogram shifting without biological mutation.

### RELATED ART

A DNA sequence consists of a coding DNA and a non-coding DNA, and watermarks are inserted into the two regions, respectively, such that data can be hidden. In the case of the coding DNA, a redundancy codon range is extremely small, and thus the coding DNA is not suitable for reversible watermarking. In the case of the non-coding DNA, a watermark available range is wide compared to the coding DNA due to no condition for protein code preservation, and thus the non-coding DNA is suitable for DNA reversible watermarking.

Lossless compression and difference expansion (DE)-based methods widely used in conventional reversible image watermarking have been proposed by T. Chen, et al. (reference [1]). A histogram-based reversible DNA watermarking method with a low modification rate of bases has been proposed by Huang, et al. (reference [2]). In this method, the modification rate of bases is low, but bpn is extremely low and a false start codon occurs, similar as Chen's method.

Furthermore, a piecewise linear chaotic map (PWLCM)-based information hiding method has been proposed by Liu, et al. (reference [3]). Information hiding methods for tamper location detection and restoration of a DNA sequence have been proposed by J. Fu (reference [4]) and Ma (reference [5]). These methods are for hiding data using substitution by complementary rule, and non-blind methods requiring a reference (or original) DNA sequence for extraction and restoration.

The foregoing is intended merely to aid in the understanding of the background of the present invention, and is not intended to mean that the present invention falls within the purview of the related art that is already known to those skilled in the art.

### SUMMARY

Accordingly, the present invention has been made keeping in mind the above problems occurring in the related art, and the present invention is intended to propose a reversible DNA information hiding method based on prediction-error expansion and histogram shifting, the method being capable of false start codon prevention, original sequence length preservation, high watermark capacity, and blind detection based on prediction-error expansion and histogram shifting without biological mutation.

In order to achieve the above object, according to one aspect of the present invention, there is provided a reversible DNA information hiding method based on prediction-error expansion and histogram shifting, the method including: coding, at a first step, a four-letter base sequence of a non-coding region DNA to an n order code value; embedding, at a second step, multiple bits for each code value by a least square (LS) prediction error; embedding, at a third step, an n order watermark bit by non-circular histogram and circular histogram multi-level shifting; verifying, at a fourth step, occurrence of a start code of a watermarked intra code value and a watermarked inter code value.

At the first step, b may be a four-letter base b={‘A’, ‘T’, ‘C’, ‘G’}, b may be a base value of the b, x may be a base block consisting of n bases, x may be a code value for the base block x, and n may be a coding order. Coding to a 2n-bit code value x in units of the base block x consisting of the n bases may be performed as follows

$$x = f ( x ) = {\sum }_{k = 1}^{n} ( {b}_{k} \cdot {2}^{2 ( n - k )} )$$

where x=(b₁, b₂, . . . , bₙ), x∈┌0,2²ⁿ−1┐. The bases of the base block may be restored from the code value x as follows f⁻¹(x)=x where bₖ=(x>>2(n−k))%4 for k=1, . . . , n.

At the fourth step, preventing of a false start codon in the watermarked intra code value may include: generating a code value table containing the false start codon in advance; and embedding a watermarked code value not to contained in the code value table.

At the fourth step, preventing of a false start codon in the watermarked intra code value may include: when a previous watermarked code value x′ᵢ₋₁ is given, a number of embedded bits for a current processed code value is controlled such that the current processed code value x′ᵢ does not satisfy

x′ᵢ₋₁(n−1,n)∥x′ᵢ(1,2)∈Z^{c}

if (x′ᵢ₋₁%2⁴)=f(‘AT’)=1 and (x′ᵢ>>2(n−1))%2²=f(‘G’)=3

if (x′ᵢ₋₁%2²)=f(‘A’)=0 and (x′ᵢ>>2(n−2))%2⁴=f(‘YG’)=7.

At the second step, the code value may be predicted through local prediction for each embedding region.

The present invention has been made keeping in mind the above problems occurring in the related art. According to the reversible DNA information hiding method based on prediction-error expansion and histogram shifting, false start codon prevention, original sequence length preservation, high watermark capacity, and blind detection based on prediction-error expansion and histogram shifting are possible without biological mutation

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A and 1B are views illustrating a general 2-bit base value and a 2n-bit value for n order base blocks, respectively;

FIGS. 2A and 2B are views illustrating occurrence probability of a false start codon in an intra code value and in inter code values, respectively;

FIGS. 3A and 3B are views illustrating, with respect to the coding order n with x=1, a ratio R_{region}(n) of the number of embedding regions and a ratio R_{base}(n) of the number of bases, and a code value level and the number of code values when the number of bases is 100;

FIGS. 4A and 4B are views illustrating an expandable region of x for a prediction value \hat{x}, and the number of expandable bits of x with the prediction value \hat{x}=0, 128, 255

$$α ( k ) = sgn ( d ) {\sum }_{i = 0}^{k - 1} {2}^{j} {ω}_{j + 1} ,$$

when all watermark bits have values of one, w={1}₁²ⁿ⁻¹.

FIGS. 5A and 5B are views illustrating code values of ‘AE017199’ and ‘CP000473.1’ sequences, histograms of the code values, successive predictor difference histograms when the coding orders are n=3 and n=4;

FIGS. 6A and 6B are views illustrating mean error histograms of LS predictors, mean predictors, and successive predictors of ‘AE017199’, ‘CP000473.1’ sequences when the coding orders are n=1 and n=4;

FIG. 7 is a view illustrating shift of values where differences from a center value Rᵢ are d>0 and d<0 on an arbitrary section Pᵢ of an n order code value histogram domain Z;

FIGS. 8A and 8B are views illustrating code value shifting on a current section Pᵢ and left and right adjacent sections Pᵢ₋₁ and Pᵢ₊₁, and code value shifting between each section and left and right adjacent sections on the entire sections; and

FIG. 9 is a view illustrating data hiding based on circular histogram shifting.

### DETAILED DESCRIPTION

According to a preferred embodiment of the present invention, a reversible DNA information hiding method based on prediction-error expansion and histogram shifting is a method using difference expansion (DE) of a multi-bit base code value and histogram shifting, and main features of the present invention are as follows.

1. Blind Reversibility: a reversible watermark is hidden without change in the length of a DNA sequence and in amino acid, and extraction and restoration are possible without an original DNA sequence.

2. Watermarking Usability: a base bit sequence of a bit is encoded to a code value sequence of 2n bits, such that reversible watermark hiding, extraction, and restoration processes are easily performed.

3. Watermark Capacity: based on DE and histogram shifting of a code value sequence, multi-bit embedding for each target code value is enabled, and thus watermark capacity is increased.

4. No false start codon: through a false start codon—code value table and comparison-search between adjacent code values, occurrence of a false start codon in an intra code value and inter code values is prevented.

Before description of the present invention, symbols used in the present invention are defined as follows.
A DNA sequence consists of a non-coding region D^{nc} and a coding region D^{c}.
The non-coding region D^{x} is divided into an embedding region Γ and a non-embedding region Γ^{C}=D^{nc}−Γ.
An embedding target region Γ has regions Dᵢ of |Γ| numbers, and each region Dᵢ consists of bases of |Dᵢ| numbers; Γ={Dᵢ}ᵢ₌₁^{|Γ|}, Dᵢ={bⱼ}ᵢ₌₁^{|D}^{ₜ}^{|}.
b is a four-letter symbol base b={‘A’, ‘T’, ‘C’, ‘G’}, and b is a base value of b.
x={b₁, b₂, . . . , bₙ} is a base block consisting of n bases, and x is a code value for the base block x. Here, n is called a coding order.
x′ is a watermarked code value, and x′={b′₁, b′₂, . . . , b′ₙ} is a base block of x′.
W={w₁, w₂, . . . , w_{N}_{_{w}}}, w∈[0,1] is a watermark bit string to be hidden.

Cardinality |D| of a matrix L indicates the number of elements or length of L.

1. Coding of Four-Letter Base

For ease of watermarking signal processing on a four-letter base sequence, multi-bit coding processing is essential. In this section, the multi-bit coding processing for ease of watermarking signal processing and false start codon prevention will be described.

1-1. Coding Based on a Coding Order

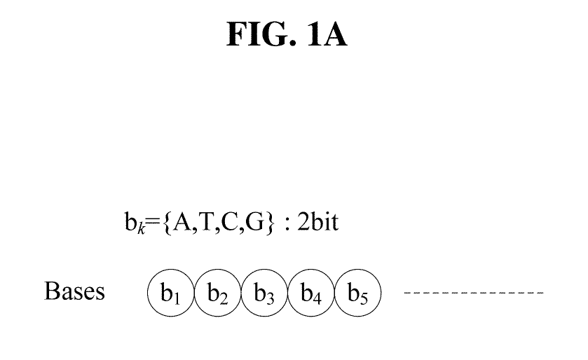

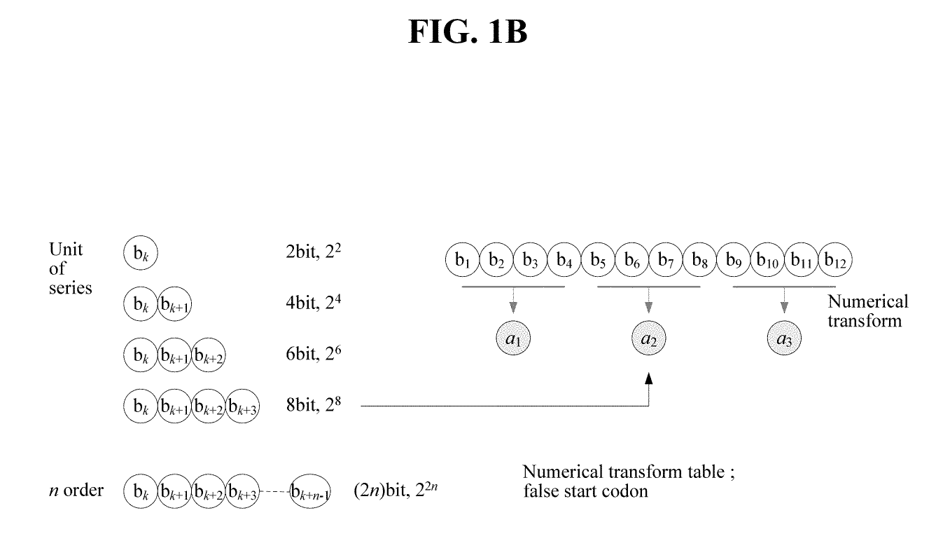

Generally, a nucleotide base is expressed as four letters, b=(A, T, C, G) as shown in FIG. 1A, that are expressed as four decimal numbers or 2-bit binary numbers.

b=(0,1,2,3)₁₀=(00,01,10,11)₂←b=(A,T,C,G) (1)

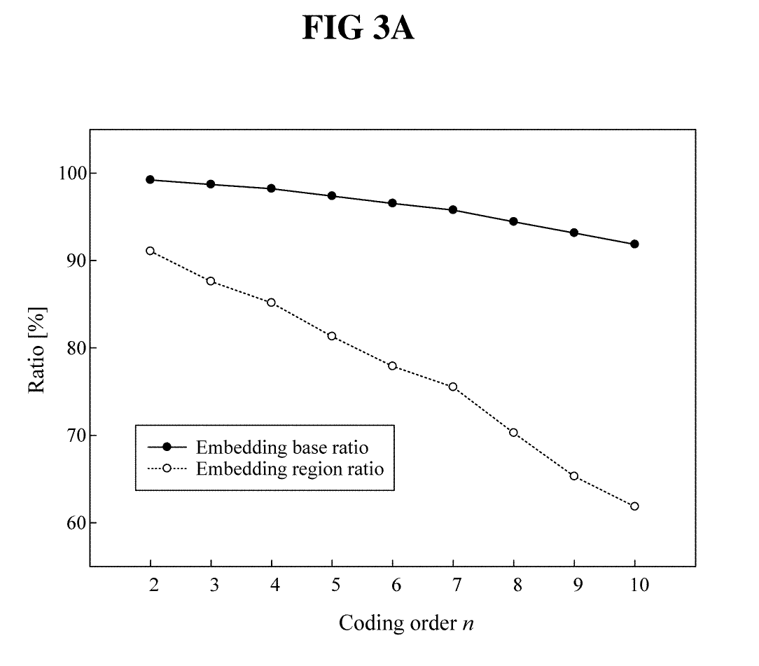

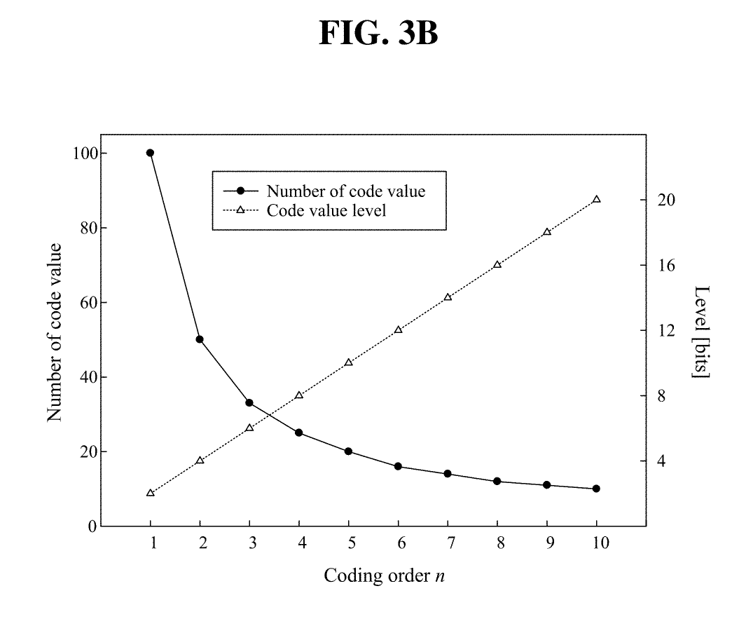

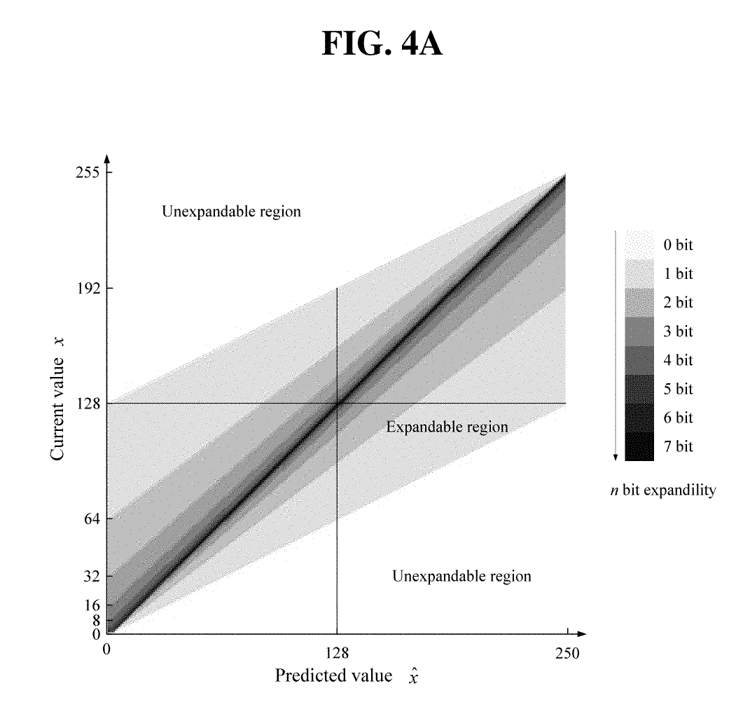

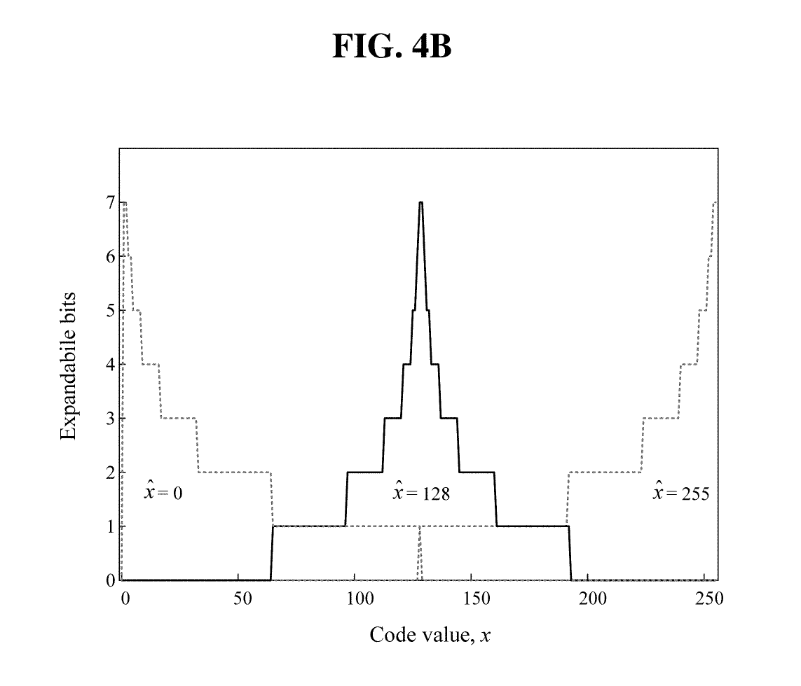

For ease of signal processing, rather than a 2-bit value, as shown in FIG. 3B, expansion to a value expressed in multiple bits of two or more bits is required. In the present invention, coding to a 2n-bit code value x in units of a base block x consisting of n bases is performed as follows.

$$\begin{matrix}x = f ( x ) = {\sum }_{k = 1}^{n} ( {b}_{k} \cdot {2}^{2 ( n - k )} ) where & ( 2 ) \\ x = ( {b}_{1} , {b}_{2} , … , {b}_{n} ) , x ∈ ⌈ 0 , {2}^{2 n} - 1 ⌉ & \end{matrix}$$

The bases of the base block are easily restored from the code value x as follows.

f⁻¹(x)=x where bₖ=(x>>2(n−k))%4 for k=1, . . . ,n (3)

In the present invention, the number n of bases of the base block is called a coding order. Bases in the embedding region Dᵢ are coded to a code value Xᵢ based on the coding order n; Xᵢ={xₖ|k∈[1,Nᵢ]}, Nᵢ=└|Dᵢ|n┘. Here, the number Nᵢ of code values is determined by the coding order n.

1-2. False Start Codon Prevention

The false start codon may occur in an intra code value or inter code values as follows.

1) Intra Code Value

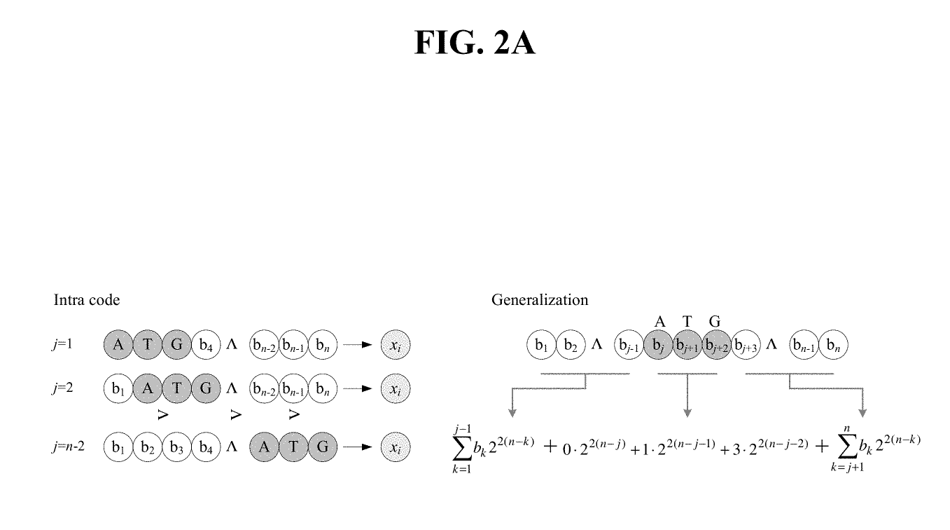

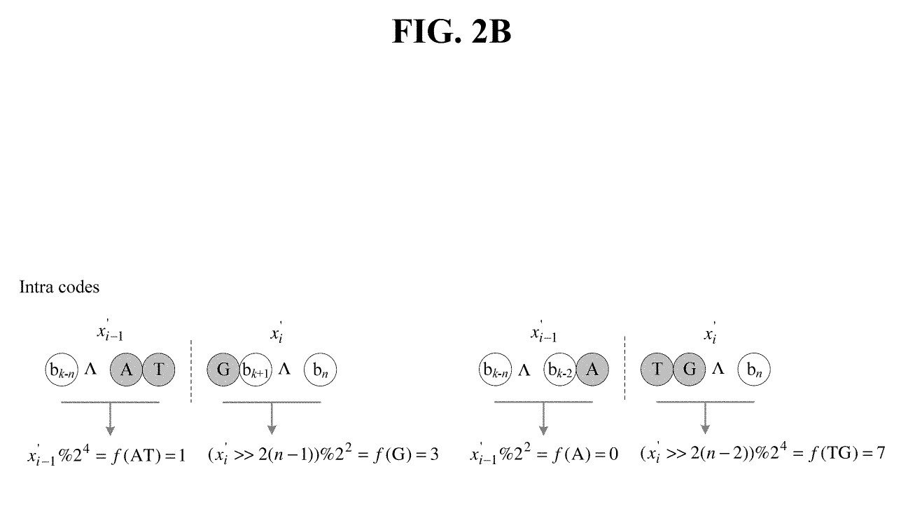

a code value domain based on the coding order n is z∈Z=┌0,2²ⁿ−1┐. In the case of n>2, as shown in FIG. 2A, false start codons of n−2(n>2) numbers may occur in the code value domain. The number of code values containing false start codons occurring at arbitrary positions j∈[1,n−2] in the base block is 2²⁽ⁿ⁻³⁾ and thus the total number of code values containing false start codons occurring at n−2 positions is (n−2)×2²⁽ⁿ⁻³⁾. The code value containing the false start codon z′ is defined as follows.

$${z}^{C} = {\sum }_{k = 1}^{j - 1} {b}_{k} {2}^{2 ( n - k )} + 0 \times {2}^{2 ( n - i )} + 1 \times {2}^{2 ( n - j + 1 )} + 3 \times {2}^{2 ( n - j + 2 )} + {\sum }_{k = j + 3}^{n} {b}_{k} {2}^{2 ( n - k )} \qquad ( 4 )$$

for ∀j=[1,n−2] and ∀bₖ∈[A,T,C,G], k=1, 2, . . . , j−1, j+3, . . . , n

Here, the symbols ‘A’, ‘T’, and ‘G’ correspond to 0, 1, and 3 as shown in Formula (3), and except for consecutive bases {A,T,G} on arbitrary positions, all bases at remaining positions have {A, T, C, G}. According to the present invention, in coding of the base, a code value table Z^{c}={z^{c}} including the false start codon is generated in advance, and then an embedding process is performed for a watermarked code value x′ not to be included in the Z.

2) Inter Code Values

The false start codon may occur between a base block x′ᵢ₋₁ of a previous watermarked code value x′ᵢ₋₁ and a base block x′₁ of a current processed code value x′₁. As shown in FIG. 2B, in the case of (x′ᵢ₋₁ x′ᵢ), when ( . . . A, TG . . . ) or ( . . . AT, G . . . ) the false start codon occurs in the middle portion thereof. Thus, two code values including the false start codon therebetween are defined as follows.

x′ᵢ₋₁(n−1,n)∥x′ᵢ(1,2)∈Z^{c} (5)

if (x′ᵢ₋₁%2⁴)=f(‘AT’)=1 and (x′ᵢ>>2(n−1))%2²=f(‘G’)=3

if (x′ᵢ₋₁%2²)=f(‘A’)=0 and (x′ᵢ>>2(n−2))%2⁴=f(‘YG’)=7.

x(j,j+1) indicates the j-th and j+1-th bases of the code value x, and ∥ indicates a concatenation operator. x′ᵢ₋₁(n−1,n)∥x′ᵢ(1,2) indicates a code value where the n−1-th and n-th bases of x′ᵢ₋₁ are concatenated with the first and second bases of x′ᵢ. In the present invention, when the previous watermarked code value x′ᵢ₋₁ is provided, the number of embedded bits for the code value xᵢ is controlled to prevent the current watermarked code x′ᵢ from satisfying the above condition.

2. Embedding Region (Target Region) Selection

In the present invention, a watermark is embedded into a code value string generated in units of a base block. Here, a region with a short sequence length is not suitable for a watermark embedding target due to a short code value string. Thus, the embedding region is a region having a or more code values, and a set Γ(n) of embedding regions for the coding order n is defined as follows.

Γ(n)={Dᵢ∥Dᵢ|>αp×n},Dᵢ={bᵢᵢ|j∈[1,|Dᵢ|]} (6)

Here, Dᵢ indicates the i-th embedding region, bᵢᵢ indicates the j-th four-letter base in the Dᵢ region, and |Dᵢ| indicates the number of bases in Dᵢ. α indicates the minimum number of code values in the embedding region, and x indicates a prediction order, which will be described in section 3. According to an embodiment of the present invention, the minimum value of code values is set to 10 or more, and the embedding region is selected based on the prediction order x.

A ratio of the number of embedding regions to the total number of non-coding regions on the given DNA sequence is designated by R_{region}(n), and a ratio of the number of bases in embedding regions to the number of bases in total non-coding regions is designated by R_{base}(n). FIG. 3A shows the ratio R_{region}(n) of the number of embedding regions and the ratio R_{base}(n) of the number of bases when the coding order n ranges 2 to 10 on the DNA sequence. FIG. 3B shows the code value level with respect to the coding order n and the number of code values, when the number of bases is 100. Referring to these figures, R_{region}(n) decreases in proportion to increase of n, but R_{base}(n) is maintained at 92% or more. In the case where the number of bases is given, when n increases, the number of code values geometrically decreases, but the code value level increases. That is, when the code value level is high, the range of watermarking signal processing is wide and the number of bases is maintained, but the number of target code values is small, and thus watermark capacity is limited. In the present invention, since multiple bits per code value are embedded, when the code value level increases, the number of embedded bits per code value increases, but the number of code values decreases. Thus, on the given non-coding region, the optimum coding order n for the watermark capacity is required.

3. Code Value Prediction-Error Expansion (PE)-Based Reversible Watermarking

When a code value of the non-coding region is given, a prediction-error expansion method used in a conventional image data may be used to embed a bit in a pair of code values. For example, when a prediction \hat{x} value a with respect to an arbitrary code value x and a watermark bit w are given, the embedded code value x′ is as follows.

x′=\ddot{x}+2(x−\ddot{x})+w=2x−\ddot{x}+w (7)

Watermark extraction and code value restoration are easily obtained from \ddot{x} and x′ as

$$w = {x}^{′} - \hat{x} - 2 ⌊ \frac{{x}^{′} - \hat{x}}{2} ⌋ , x = \frac{1}{2} ( {x}^{′} + \hat{x} - w ) .$$

This method is suitable for image data with high correlation between adjacent pixels. By a prediction error modeled as Laplacian distribution, one bit can be embedded into each of pixel pairs.

However, code values of the DNA sequence have a low correlation between successive predictors, and thus an adaptive prediction is required. Also, code values can be moved without limitation under false start codon limitation conditions, and thus multiple bits can be embedded in a pair of code values. Thus, in this section, a code value prediction-error expansion-based multi-bit embedding method will be described.

3-1. Code Value Error Expansion Condition for Multi-Bit Embedding

Except for false start codon values, DNA code values having no condition for definition move without limitation within a valid range. Thus, the prediction error d for a pair of code values can be expanded 2^{k} times according to an expansion condition to embed k bits, and at most 2n−1 bits can be embedded; kₘₐₓ=2n−1.

When k bits of watermark {wⱼ}₁^{k} and a prediction value \hat{x} are given, a k-bit embedded code value x′ is obtained by the 2^{k} times expanded prediction error d as follows.

$${x}^{′} = \hat{x} + {2}^{k} d + sgn ( d ) {\sum }_{i = 1}^{k} {2}^{j - 1} {w}_{1} where d = x - \hat{x} \qquad ( 8 )$$

When the embedded code value x′ and the number k of bits are given, watermark extraction and restoration are easily performed as follows.

wᵢ=((x′−\hat{x})>>(j−1))%2 for j=1, . . . ,k (9)

x=\hat{x}+d=\check{x}+(x′−ĉ)>>k (10)

Since the embedded code value x′ is desired to be 0≤x′≤2²ⁿ−1, expansion condition of the prediction error d for 2^{k} times expansion is as follows.

$${2}^{- k} ( - \hat{x} - sgn ( d ) {\sum }_{i = 1}^{k} {2}^{j - 1} {w}_{j} ) ≦ d ≦ {2}^{- k} ( {2}^{2 n} - 1 - \hat{x} - sgn ( d ) {\sum }_{i = 1}^{k} {2}^{j - 1} {w}_{j} ) \qquad ( 11 )$$

The code value x is desired to satisfy the condition as follows.

x∈[max(0,┌ĉ+2^{-k}(−\hat{x}−α(k))┐),min(2²ⁿ−1, └\hat{x}+2^{-k}(2²ⁿ−1−\hat{x}−α(k)┘)], (12)

where

$$α ( k ) = sgn ( d ) {\sum }_{i = 1}^{k} {2}^{j - 1} {w}_{j} .$$

Such the expansion condition is determined depending on watermark k bits and {wⱼ}₁^{k} the prediction value \hat{x}, and the number of bits to be embedded in the code value x is determined depending on the expansion condition.

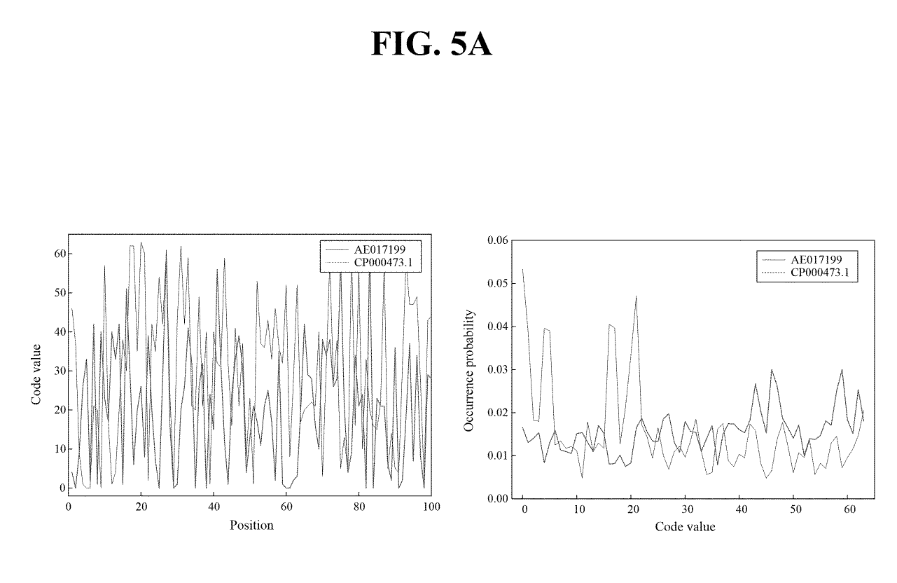

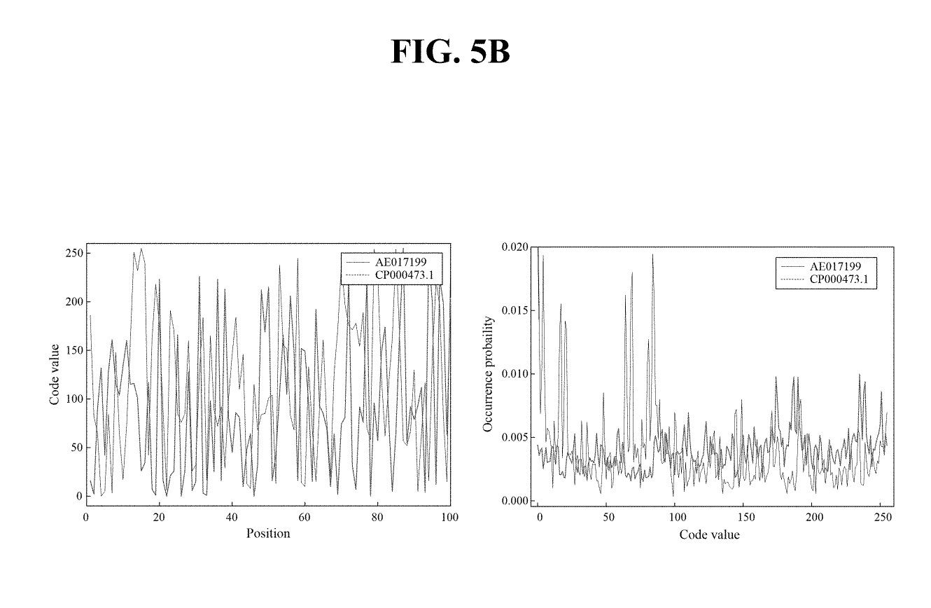

FIG. 5A shows the number of bits to be embedded in the code value x for each prediction value \hat{x} when the coding order is n=4 (x,\hat{x}∈┌1,2^{s}−1┐) and all watermark bits are 1 w={1}. The maximum number kₘₐₓ of embedded bits is 2n−1=7. FIG. 5B shows a range of code values x depending on the number of embedded bits when the prediction value \hat{x} is 0, 128, and 255. When the number of embedded bits is large, an expandable region is geometrically narrow, and when \hat{x} is close to 0 or 255, the number of embedded bits is small.

3.2 Code Value Prediction

FIGS. 5A and 5B show code values and code value histograms of ‘AE017199’ and ‘CP000473.1’ sequences, when the coding orders n are 3 and 4. The code value histogram is expanded or reduced depending on the coding order, but distribution is not standardized depending on the sequence. That is, code values of the ‘AE017199’ sequence are evenly distributed in, except for four regions, the remaining regions, and code values of the ‘CP000473.1’ sequence are evenly distributed with white noise in the whole regions. Also, the code value sequence appears in random form, and correlation between successive predictors is extremely low. Thus, in the present invention, in order to reduce the prediction error for the code value, the code value is predicted based on a local LS predictor, such as Dragoi, etc.

A row vector of x code values for predicting the current code value xᵢ is xᵢ=(xᵢ₋₁, . . . , xᵢ₋ᵥ) and a row vector of x parameter is b=(β₁, . . . , βᵥ). Here, x indicates a prediction order. When xᵢ is observed, the prediction value \hat{x}₁ of x₁ is defined by a linear regression function ƒ_{β}(x) as follows.

$${\hat{x}}_{i} = {f}_{β} ( {x}_{i} ) = {\sum }_{i = 1}^{p} {β}_{j } {x}_{i - j} = {x}_{i} {b}^{′} \qquad ( 13 )$$

When a row vector of all code values in an arbitrary embedding region is y=(x₁, . . . , x_{N}) and N×p matrix of N observed previous code values is X=(x′₁, . . . , x′_{N}), LS predictor computes parameter t that minimizes the square distance) ∥y′−Xb′∥²=(u′−Xb′)′(u′−Xb′) between u′ and Xb′ as follows.

b=(X′X)⁻¹X′y′ (14)

In the present invention, rather than whole prediction on whole embedding regions, local prediction for each embedding region is performed to predict the code value. Thus, in decoding process, additional information of |Γ(n)|×t which is parameter t by the number |Γ(n)| of embedding regions of the DNA sequence is required.

The code value may be predicted using a successive predictor \hat{x}ᵢ=xᵢ₋₁ or a mean predictor

$${\hat{x}}_{i} = {\sum }_{i = 1}^{p} {x}_{i - j} / p .$$

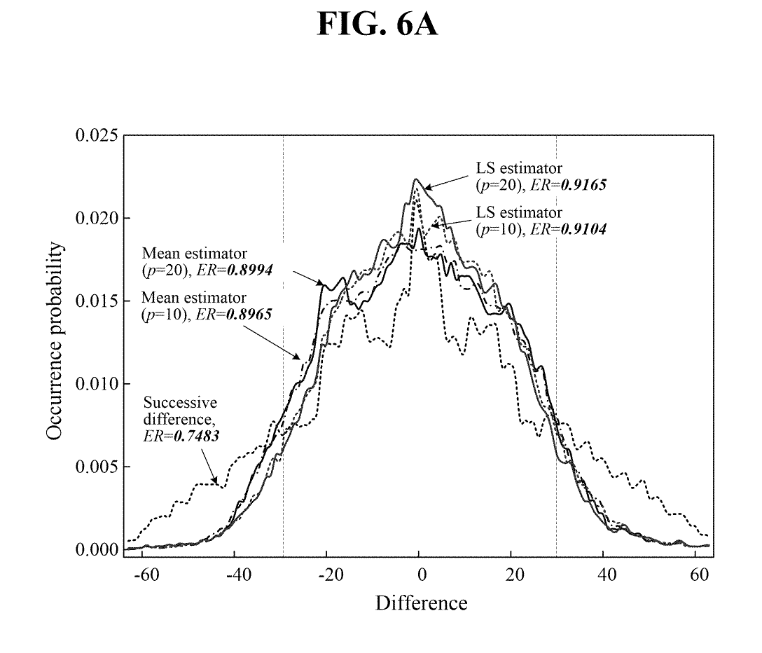

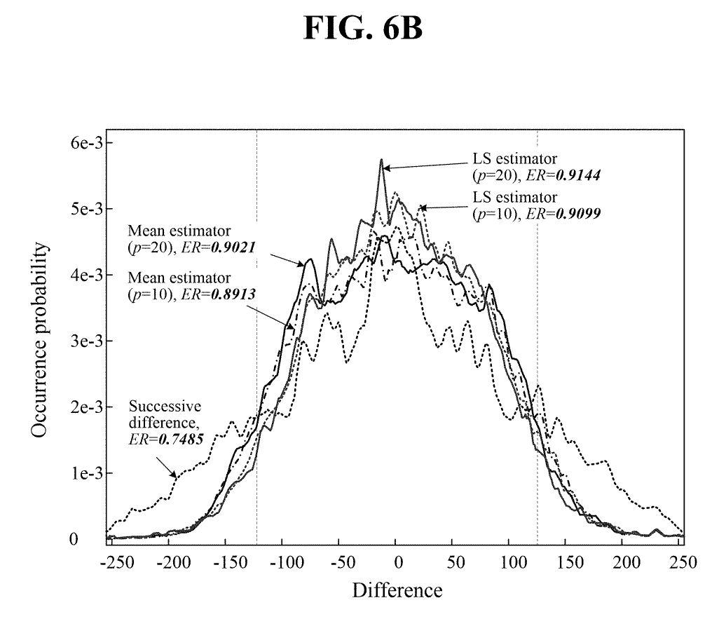

FIGS. 6A and 6B show prediction error histograms for successive predictors, mean predictors, and LS predictors when the coding orders are n=3 and n=4 for ‘AE017199’ and ‘CP000473.1’ sequences (p is a prediction order (the number of successive predictors used in prediction), and ER (expandable region) is expansion region occurrence probability).

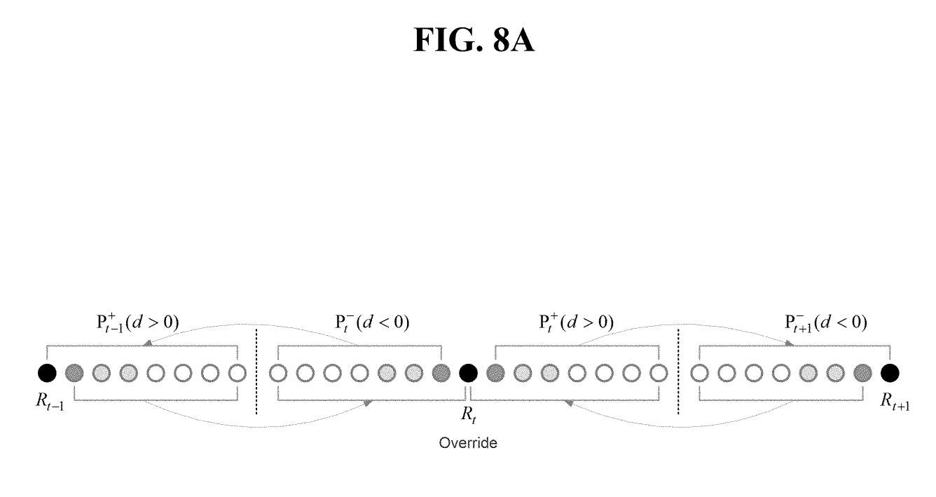

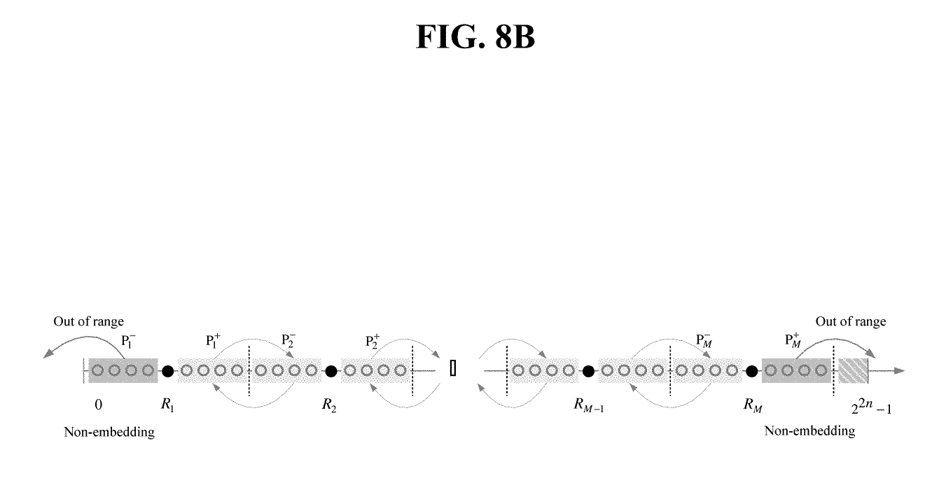

In FIG. 8, ER indicates expansion region occurrence probability. A successive predictor error has an ER of about 74.8% regardless of the coding order. The mean predictor and the LS predictor have relatively high ER in the case of the coding order n=3, and when the prediction order x is high, ER is high. Particularly, in the case of n=3 and x=20, the LS predictor has the highest ER of 91.6%. That is, in the case of n=3, when the prediction order x of LS is high, insertion capacity is large.

The prediction error histogram of an image is modeled as Laplacian distribution, but the LS prediction error histogram of the code value is modeled as normal distribution that (μ,σ)=(0,20) with n=3 and x=10, (μ,σ)=(0,19) with n=3 and x=20, (μ,σ)=(0,80) with n=4 and x=10, and (μ,σ)=(0,76) with n=4 and x=20.

3.3 Coding Process

In the coding process of the present invention, when the coding order n and the prediction order are given, an LS prediction parameter t is obtained for each embedding region. The LS predictor by t is used for the code value xᵢ with i>p, and the mean predictor is used for the code value with i≤x, thereby obtaining \hat{x}₁.

$${\hat{x}}_{i} = \{ \begin{matrix}{\sum }_{j = 1}^{p} {β}_{j} {x}_{i - j} , & if i > p \\ {\sum }_{j = 1}^{i - 1} \frac{{x}_{i - j}}{i - 1} , & if 1 < i ≦ p \\ 0 , & if i = 1\end{matrix} \qquad ( 15 )$$

After determining the number kᵢ (0≤kᵢ≤2n−1) of embedded bits based on expansion condition of the prediction error dᵢ=xᵢ−\hat{x}₁, k₁ bits {w_{I}}_{I=1}^{k}^{₁} are embedded in the code value x₁ as follows.

$${x}_{i}^{′} = {\hat{x}}_{i} + {2}_{i}^{k} {d}_{i} + α ( {k}_{i} ) where α ( {k}_{i} ) = sgn ( {d}_{i} ) {\sum }_{I = 1}^{{k}_{i}} {2}^{I - 1} {w}_{I} \qquad ( 16 )$$

x′ᵢ∉Z^{t} and x′ᵢ₋₁(n−1,n)∥x′ᵢ(1,2)∉Z^{t}

When the embedded code value x′₁ is included in a false start codon tale Z^{t} or the previous code value x′ᵢ₋₁ includes the false start codon, the number kᵢ of embedded bits is reduced by one, and then the above-described process is repeated until kᵢ is zero. In this way, multiple bits are embedded in code values of all embedding regions, and then a watermarked region Γ′(n) is obtained. When kᵢ is 0, it indicates a non-embedding region of the prediction error or a case where the false start codon occurs.

The number K={kᵢ} of embedded bits for each code value and the prediction parameter t for each embedding region are additional information required in watermark extraction and original sequence restoration. It is required that the additional information is included in the watermarked region Γ′(n) and is transmitted without occurrence of the false start codon and generation of another additional information. In the present invention, by arithmetic coding, lossless compression is performed on the number K of embedded bits, the prediction parameter t, and an LSB bit E of a 2-bit base binary number in Γ′(n), thereby generating a compression bit string C={cᵢ}. The compression bit cᵢ is substituted to the LSB of the binary number b′ᵢ of the four-letter base as follows.

b′ᵢ=(b′ᵢ>>1)<<1+c₁, if b′_{i-2≠‘A’} and b′_{i-1≠‘T’} (17)

Here, in a case where two previous embedded bases (b′₁₋₂,b′₁₋₁) are “AT”, when the current base is b′₁=‘G’, b′₁ is substituted by one of ‘A’, ‘T’, and ‘C’. When b′₁≠‘G’, embedding is omitted. Finally, a base string “AT” in the embedding region Γ″(n) including a compression string C performs as a marker directly indicating that a subsequent base does not include a compression bit. The length of the compression string C is determined by a compression algorithm, but in the present invention, arithmetic coding which is a general lossless compression algorithm is used. Consequently, the DNA sequence D′=D^{nc}+D^{c}, D^{nc}=Γ″(n)+Γ^{c}(n) containing the additional information and the non-coding region Γ″(n) where the watermark is embedded is transmitted.

3.4 Decoding and Restoration Processes

In decoding process, in the non-coding region Γ″(n) of the DNA sequence D′ transmitted first, from the LSB of all bases except for the base following “AT”, the number K of embedded bits of the additional information compression string C, the prediction parameter t, and the base LSB bit E are obtained. The code sequence X′ of Γ′(n) where the base LSB bit E of Γ″(n) is substituted is obtained by the coding order n. From all code values in X′, the watermark is extracted by the number K of embedded bits and the prediction parameter t, and the original code value is restored.

For example, when the number of embedded bits kᵢ>0 and arbitrary code value x′ᵢ are given, the prediction value \hat{x}₁ is obtained from the previous restored code value (xᵢ₋₁, . . . , xᵢ₋ᵥ), and then the watermark k₁ bit is extracted from the prediction error dᵢ=x′ᵢ−\hat{x}₁, w₁=((x′ᵢ−\hat{x}ᵢ)>>(l−1))%2 for l=1, . . . , kᵢ. The original code value xᵢ is restored by kᵢ bit shifting of the prediction error dᵢ as xᵢ=\hat{x}ᵢ+((x′ᵢ−\hat{x}ᵢ)>>kᵢ).

3.5 Watermark Capacity and Additional Information Amount

Watermark capacity is affected by the coding order n and the prediction order x. When n and x are given, the number of watermark bits embedded in the embedding region Γ(n)={Dᵢ}ᵢ₌₁^{|Γ(n)|} is the sum of the number K of embedded bits for each code value in the region. Thus, the number of bits per base (bpn) bpn_{FE}(n,p) is as follows.

$${bpn}_{PE} ( n , p ) = \frac{1}{\vert Γ ( n ) \vert} {\sum }_{i = 1}^{\vert Γ ( n ) \vert} ( \frac{1}{{N}_{i}} {\sum }_{i = 1}^{{N}_{i}} {k}_{j} ) [ bit \text{/} base ] \qquad ( 18 )$$

where Nᵢ=└|Dᵢ|/n┘ and 0≤kᵢ≤2n−1

|Γ(n)| indicates the number of embedding regions, and Nᵢ indicates the number of code values in the region Dᵢ.

When [symbol] is LSB substitutable bit amount to embed the additional information compression string C, [symbol] is determined by the number of bases omitted by the false start codon in substituting process. The maximum [symbol] is equal to the total number

$${\sum }_{i = 1}^{\vert Γ ( n ) \vert} \vert {D}_{i} \vert$$

of bases in Γ′(n). It is required that the length of the additional information compression string C is less than the substitutable bit amount [symbol] , the amount of the additional information that is the number K of embedded bits, the prediction parameter t, and the LSB E of 2-bit base is small, or an algorithm with high compression efficiency is required. When an arbitrary watermarked region D′₁ (∈Γ′(n)) is given, E consists of |Dᵢ| bits, and the number K of embedded bits is expressed by Nᵢ┌log₂2n┐ bits, and the prediction parameter t for each embedding region is expressed by x floating points of 32 bits. Thus, additional information Extra_{PB}(n,p) for Γ′(n) is as follows.

$${Extra}_{PE} ( n , p ) = {\sum }_{i = 1}^{\vert Γ ( n ) \vert} ( {N}_{i} ⌈ {log}_{2} 2 n ⌉ + \vert {D}_{i} \vert + 32 p ) [ bit ] \qquad ( 19 )$$

When the additional information compression string C is ρ×Extra_{PB}(n,p), compression is performed to be

$$ρ \times {Extra}_{PE} ( n , p ) < Φ ≦ {\sum }_{i = 1}^{\vert Γ ( n ) \vert} \vert {D}_{i} \vert .$$

4. Code Value Histogram Shifting-Based Method

Code values in a non-coding region may be shifted to, except for a code value table having the false start codon, a remaining region. In this section, non-circular and circular code value histogram shifting-based methods for increasing data capacity will be described.

4.1 Non-Circular Histogram Shifting (HS)

(1) Coding Process

In the present invention, an n order code value histogram domain Z=┌0,2²ⁿ−1┐ is divided into M sections {Pᵢ}ᵢ₌₁^{M}. Here, each section is provided in bilateral symmetry with respect to a center value Rᵢ, and Rᵢ is used as a reference value of shifting. Thus, the length of the section has a value of an odd number, and is determined by the number of embedded bits.

When the maximum number of shifting bits in the section is kₘₐₓ and the center value is Rᵢ=z, Pᵢ consists of 2×2ₘₐₓ^{k}−1 values as follows.

Pᵢ={z−2^{k}^{ₘₐₓ}+1, . . . ,z−1·z,z+1, . . . ,z+2^{k}^{ₘₐₓ}−1},for j∈[1,M] (20)

Rᵢ=z (21)

The number M of sections is as follows.

$$M = ⌊ \frac{{2}^{2 n}}{2 \times {2}_{max}^{k} - 1} ⌋ where 1 ≦ {k}_{max} ≦ 2 n - 1 \qquad ( 22 )$$

Here, a residual section of 2²ⁿ−(2×2ₘₐₓ^{k}−1)M values is Z^{c}=Z⁻␣ᵢ₌₁^{M}Pᵢ, and is not selected for watermark embedding.

When an arbitrary code value x₁ belongs to the section Pᵢ, a difference from the center value R₁ of the section is dᵢ=xᵢ−R₁, xᵢ∈P₁. Here, based on the range of |dᵢ|, the number k₁ of bits to be embedded in x₁ is determined as follows.

$${\sum }_{I = 0}^{{k}_{i} - 1} {2}^{n} < \vert {d}_{i} \vert ≦ {\sum }_{I = 0}^{{k}_{f}} {2}^{n} , {k}_{i} ≧ 1 , if {x}_{i} \neq {R}_{1} \qquad ( 23 )$$

kᵢ=0, if xᵢ=R₁

Next, k₁ bits {w_{I}}_{I=1}^{k}^{_{f}} are embedded in x₁ as follows.

$${x}_{i}^{′} = {R}_{i} + {2}_{i}^{k} {d}_{i} + α ( {k}_{i} ) where α ( {k}_{i} ) = sgn ( {d}_{i} ) {\sum }_{I = 1}^{{k}_{f}} {2}^{t - 1} {w}_{1} , \qquad ( 24 )$$

x′ᵢ∉Z^{t} and x′ᵢ₋₁(n−1,n)∥x′ᵢ(1,2)∉Z^{t}

The value xᵢ=Rᵢ which is the center value Rᵢ of the section is the number of embedded bits kᵢ=0, and is excluded from bit embedding. Here, when a shifted code value x′ᵢ is in the false start codon table Z^{t} or when the false start codon occurs between the x′₁ and the previous shifted code value x′₁, the number k₁ of embedded bits is reduced by one until reaching zero. This process is repeated. Thus, the false start codon is prevented in the same manner as a successive code value pair DE method. In this way, for all code values in the embedding target region, multiple bits are embedded depending on the number of embedded bits for each code value, and then the watermarked non-coding region Γ′(n) is obtained.

As additional information for watermark extraction and original sequence restoration, the number K={kᵢ} of embedded bits for each code value, a marker T={τ} of a section shifted based on a section reference value and the LSB bit E of the 2-bit base binary number in the watermarked non-coding region Γ′(n) are required. Like the successive code value pair DE method, a bit string C of the additional information (K,T,E) is generated with lossless compression, and then the bit string is substituted by the LSB bit of the base binary number in Γ′(n). The DNA sequence D′=D^{nc}+D^{c}, D^{nc}=Γ″(n)+Γ^{c}(n) containing the final additional information and the non-coding region Γ″(n) where the watermark is embedded is transmitted.

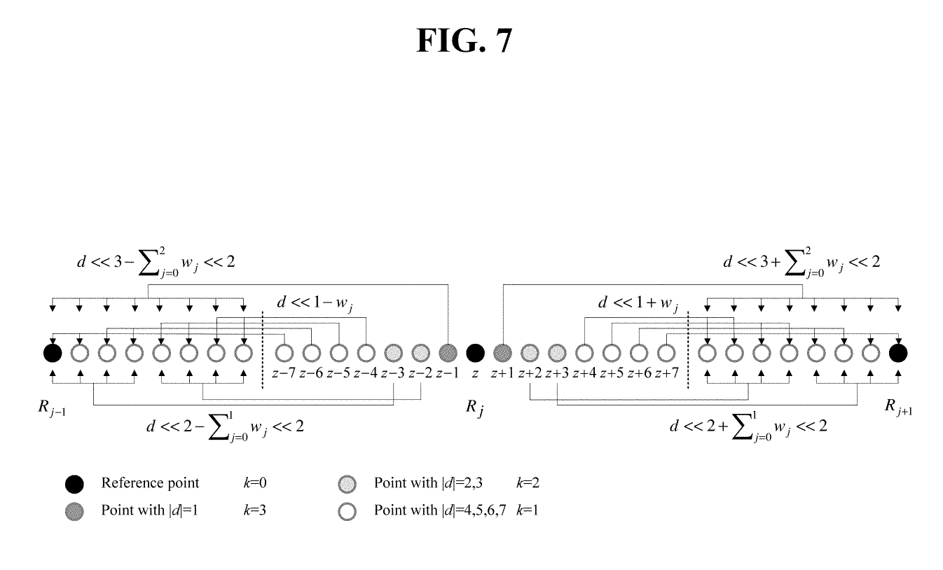

FIG. 7 shows code value shifting based on the difference |d| from the center value R₁ and a watermark bit when the maximum number of shifting bits on Pᵢ is kₘₐₓ=3. An arbitrary section Pᵢ of a histogram domain is divided into a left subsection Pᵢ⁻ and a right subsection Pᵢ⁺ based on the center value Rᵢ. In the case of |d|=1, 3-bit (k=3) embedding is possible. In the case of |d|∈{2,3}, 2-bit (k=2) embedding is possible, and in the case of |d|∈{4,5,6,7},1-bit (k=1) embedding is possible. In the case of |d|=0 and x=Rᵢ, a bit is not embedded (k=0).

The code value x corresponding to the right subsection Pᵢ⁺ (d>0) of the section Pᵢ is shifted by the watermark bit to the left subsection Pᵢ₊₁⁻(d≤0) of the right section Pᵢ₊₁. In contrast, x corresponding to the left subsection Pᵢ⁻(d<0) of the section Pᵢ is shifted by the watermark bit to the right subsection Pᵢ₋₁⁺(d>=) of the left section Pᵢ₋₁. In other words, as shown in FIG. 8A, the code value of the right subsection of the section Pᵢ and the code value of the left subsection of the right adjacent Pᵢ₊₁ are shifted to each other. In contrast, the code value of the left subsection of the section Pᵢ and the code value of the right subsection of the left adjacent Pᵢ₋₁ are shifted to each other.

Among the watermarked code values, the code value which is the center value x′ᵢ=Rᵢ is generated in three cases. First, when the previous code value is the center value xᵢ=Rᵢ (kᵢ=0), it is excluded in shifting. Thus, the original code value xᵢ=Rᵢ is not shifted. Also, as shown in FIG. 8A, the case is that values in the right subsection Pᵢ₋₁⁺ of the left section and in the left subsection Pᵢ₊₁⁻ of the right section are shifted. The case where shifting is performed and the case where shifting is not performed can be distinguished by the number of embedded bits for each code value. Thus, for extraction and restoration, the shifted previous section information T={τ} is required as follows.

$$τ = \{ \begin{matrix}0 , if {x}^{′} = {R}_{i} and x ∈ {P}_{i - 1}^{+} \\ 1 , if {x}^{′} = {R}_{i} and x ∈ {P}_{i + 1}^{-}\end{matrix} \qquad ( 25 )$$

As shown in FIG. 8B, among M sections, code values from the right subsection P₁⁺ of P₁ to the left subsection P_{M}⁺ of P_{M} are shifted. Code values corresponding to the remaining boundary sections P₁⁻ and P_{M}⁺ are assigned with the number of shifting bits k=0.

(2) Decoding and Restoration Processes

In decoding process of the present invention, from the non-coding region Γ″(n) of the DNA sequence D′ previously transmitted, the additional information (K,T,E) of the compressed bit string is obtained, and then the watermarked non-coding region Γ′(n) by base binary number substitution of E is obtained. From the code sequence X′ of Γ′(n) watermarking and original value restoration are performed by the number K of shifting bits for each code value and the marker of T={τ} a shifted section.

When the code value x′₁ of the code sequence X⁺ is given, the center value R of the original section of x′₁ is required to be obtained first. That is, when the shifted section P₁ of x′₁ is not the boundary section (x′ᵢ∈P₁) and the number k₁ of shifting bits is kᵢ>0, the center value R for the previous section of x′ᵢ is obtained as follows.

$$R = \{ \begin{matrix}{R}_{j - 1} , if {x}_{i}^{′} ∈ {P}_{i}^{-} or ( {x}_{i}^{′} = {R}_{j} and {τ}_{i} = 0 ) \\ {R}_{j + 1} , if {x}_{i}^{′} ∈ {P}_{i}^{+} or ( {x}_{i}^{′} = {R}_{i} and {τ}_{i} = 1 ) , if {x}_{i}^{′} ∈ {P}_{i} and {k}_{i} > 0\end{matrix} \qquad ( 26 )$$

Here, based on the shifted section Pᵢ of x′ᵢ, the center value R of the section before embedding is easily obtained. However, when x′ᵢ is the center value Rᵢ of the shifted region Pᵢ (x′ᵢ=Rᵢ), ℏ is obtained by the marker τᵢ of the previous section. The watermark kᵢ bits {w_{I}}_{I=1}^{k}^{ₜ} on x′₁ and the original code value x₁ are obtained using the center value R of the previous section as follows.

w_{I}=((x′ᵢ−R)>>(l−1))%2 for l=1, . . . ,kᵢ (27)

xᵢ=R+((x′ᵢ−R)>>kᵢ) (28)

(3) Watermark Capacity and Additional Information

When the coding order n and the maximum number kₘₐₓ of section shifting bits are given, the number of watermark bits embedded in the embedding region

$$Γ ( n ) = {\{ {D}_{i} \}}_{i = 1}^{\vert Γ ( n ) \vert}$$

is determined based on the number of bits defined by the difference range from the center value in the histogram domain section Pᵢ and the frequency at which the code value belongs to each section.

The frequency with z value on the code value histogram is designated by p(z). Here, the number of shifting bits on an arbitrary section Pᵢ is calculated by the sum of the number C(Pᵢ⁻) of shifting bits in the left subsection Pᵢ⁻ and the number C(Pᵢ⁺) of shifting bits in the right subsection Pᵢ⁺.

$$\begin{matrix}C ( {P}_{j}^{+} ) = {\sum }_{i = 0}^{{k}_{max} - 1} ( {\sum }_{t = 0}^{{2}^{i} - 1} p ( {R}_{j} + {2}^{i} + t ) ( {k}_{max} - i ) ) , for d > 0 & ( 29 ) \\ C ( {P}_{j}^{-} ) = {\sum }_{i = 0}^{{k}_{max} - 1} ( {\sum }_{t = 0}^{{2}^{i} - 1} p ( {R}_{j} - {2}^{i} - t ) ( {k}_{max} - i ) ) , for d < 0 & ( 30 )\end{matrix}$$

The total number of watermark bits embedded in Γ(n)={Dᵢ}ᵢ₌₁^{|Γ′(n)|}is the sum of the number of shifting bits on the remaining sections, except for the boundary sections P₁⁻ and P_{M}⁺ among total M sections, and the number of bits per base bpn bpn_{HS}(n,kₘₐₓ) is defined as follows.

$${bpn}_{HS} ( n , {k}_{max} ) = \frac{1}{{\sum }_{i = 1}^{\vert Γ ( n ) \vert} {N}_{i}} ( C ( {P}_{1}^{+} ) + {\sum }_{j = 2}^{M - 1} ( C ( {P}_{j}^{+} ) + C ( {P}_{j}^{-} ) ) + C ( {P}_{M}^{-} ) ) [ bit \text{/} base ] \qquad ( 31 )$$

|Γ(n)| is the number of embedding regions, N is the number of code values in the region Dᵢ, and

$${\sum }_{i = 1}^{\vert Γ ( n ) \vert} {N}_{1}$$

is the total number of bases in the embedding target region.

The additional information Extra_{HS}(n,kₘₐₓ) for watermark extraction and restoration is the number R of shifting bits for each code value, the marker T of the section shifted based on the section reference value, and the LSB bit E of the 2-bit base binary number of the watermarked non-coding region Γ′(n). When the maximum number of shifting bits in the histogram domain section is kₘₐₓ, the number of embedded bits is expressed by ┌log₂kₘₐ┐ bit. Thus, the number K of shifting bits for whole code values is expressed by total

$$⌈ {log}_{2} {k}_{max} ⌉ {\sum }_{i = 1}^{\vert Γ ( n ) \vert} {N}_{1}$$

bits. The marker T of the shifted section is binary information determining whether the code value x′=Rᵢ shifted based on the center value of the adjacent section is shifted from the left section or the right section, and is expressed by

$$T = {\sum }_{i = 1}^{\vert Γ ( n ) \vert} {N}_{i} \times {\sum }_{i = 1}^{M} p ( {x}^{′} = {R}_{i} )$$

bits. E is

$${\sum }_{i = 1}^{\vert Γ ( n ) \vert} \vert {D}_{i} \vert$$

bits that is the same as the number of bases of all regions in Γ′(n). Thus, additional information Extra_{HS}(n,kₘₐₓ) is as follows.

$$\begin{matrix}{Extra}_{HS} ( n , {k}_{max} ) = K + T + B \\ = ⌈ {log}_{2} {k}_{max} ⌉ {\sum }_{i = 1}^{\vert Γ ( n ) \vert} {N}_{i} + {\sum }_{i = 1}^{\vert Γ ( n ) \vert} {N}_{i} \times \\ {\sum }_{i = 1}^{M} p ( {x}^{′} = {R}_{j} ) + {\sum }_{i = 1}^{\vert Γ ( n ) \vert} \vert {D}_{i} \vert \\ = {\sum }_{i = 1}^{\vert Γ ( n ) \vert} ( {N}_{i} ( ⌈ {log}_{2} {k}_{max} ⌉ + {\sum }_{i = 1}^{M} p ( {x}^{′} = {R}_{i} ) ) + \vert {D}_{i} \vert ) [ bit ]\end{matrix} \qquad ( 32 )$$

When a compression rate is ρ, lossless compression is performed such that additional information Extra_{HS}(n,kₘₐₓ)

$$ρ \times {Extra}_{HS} ( n , {k}_{max} ) < Φ ≦ {\sum }_{i = 1}^{\vert Γ ( n ) \vert} \vert {D}_{i} \vert .$$

When the watermark bit is not embedded k=0, it corresponds to the boundary section of the histogram domain section, the residual section that do not belong to the section, and the code value that is the center value of the section. That is, k=0 probability P(k=0|x) is as follows.

$$P ( k = 0 \vert x ) = {\sum }_{t = 0}^{{R}_{1} - 1} p ( x = t ) + {\sum }_{t = {R}_{N} + 1}^{{R}_{N} + {2}^{k} max - 1} p ( x = t ) + {\sum }_{t = {R}_{N} + {2}^{k} max}^{□} p ( x = t ) + {\sum }_{j = 1}^{M} p ( x = {R}_{j} ) {\sum }_{t = 0}^{{R}_{1} - 1} p ( t )$$

is the probability of the code value in P₁⁻ section,

$${\sum }_{t = {R}_{N} + 1}^{{R}_{N} + {2}^{{k}_{max}} - 1} p ( t )$$

is the probability of the code value in P_{M}⁺ section, and

$${\sum }_{t = {R}_{N} + {2}^{{k}_{max}}}^{{2}^{zn} - 1} p ( t )$$

is the probability of the value in the residual section that do not belong to P. Last,

$${\sum }_{i = 1}^{M} p ( {R}_{j} )$$

is the probability of the code values that are the center values of all sections.

$$P ( k - 1 \vert x ) , P ( k = 2 \vert x ) , -- - P ( k = {k}_{max} \vert x )$$

$${\sum }_{i = 0}^{{k}_{max}} P ( k = i \vert x ) = 1$$

4.2 Circular Histogram Shifting (CHS)

Unlike the pixel value of the image, code values in the non-coding region have no condition for definition, and thus shifting between the maximum value and the minimum value is possible. In the circular histogram shifting method, histogram section shifting is changed to circular histogram shifting such that embedding is possible in the left subsection P₁⁻¹ (d<0) of P₁ and in the right subsection P_{M}⁺ (d>0) of P_{M} that are the boundary sections, thereby increasing watermark capacity in the non-circular histogram shifting method.

(1) Coding Process

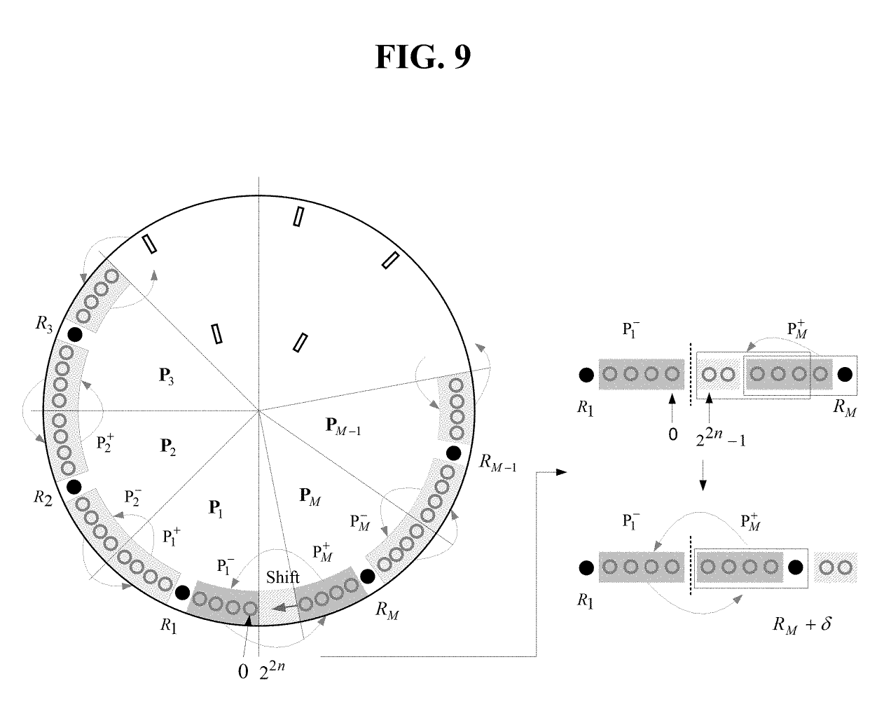

In the rest sections except for the boundary sections and the residual section, the watermark is embedded in the same manner as embedding process of the non-circular histogram shifting method. In circular form of the histogram domain section, as shown in FIG. 9, P₁⁻ and P_{M}⁺ subsections, which are two boundary sections, are not shifted by the residual section. Thus, in the present invention, P_{M}⁺ is shifted to the residual section such that two subsections of P_{M} are separated. That is, when the number of the code values in the residual section is δ=2²ⁿ−(2×2ₘₐₓ^{k}−1)M, P_{M} region is,

P_{M}=P_{M}⁻+P_{M}⁺ (33)

where P_{M}⁻={z−2^{k}^{ₘₐₓ}+1, . . . , z−1,z}, R_{M}⁻=z

P_{M}⁺={z+δ, z+δ+1, . . . , z+δ+2^{k}^{ₘₐₓ}−1(=2²ⁿ−1)}, R_{M}^{+=z+δ,}

divided into a subsection P_{M}⁻ smaller than R_{M}⁻=z and a subsection P_{M}⁺ larger than R_{M}⁺=z+δ. In P_{M} section, two center reference values are generated.

By the center value ℏ of the section P₁ to which x₁ belongs on the arbitrary code value x₁

$$R = \{ \begin{matrix}\begin{matrix}{R}_{j} , if {x}_{i} ∈ {P}_{i} for j = 1 , 2 , … , M - 1 \\ {R}_{M}^{-} , if {x}_{i} ∈ {P}_{M}^{-} for j = M\end{matrix} \\ {R}_{M}^{+} , if {x}_{i} ∈ {P}_{M}^{+} for j = M\end{matrix} , \qquad ( 34 )$$

k₁ bits {wₙ}ₙ₌₁^{k}^{_{f}} are embedded as follows.

x′ᵢ=(R+2ᵢ^{k}dᵢ+α(kᵢ))%2²ⁿ (16)

where dᵢ=xᵢ−R and

$$α ( {k}_{i} ) = sgn ( {d}_{i} ) {\sum }_{I = 1}^{{k}_{i}} {2}^{I - 1} {w}_{I}$$

Here, the number of shifting bits of the residual value [R_{M}⁻+1,R_{M}⁺−1] between P_{M}⁻ and P_{M}⁺ and the code values that are the center values of respective sections is zero.

Information T on the previous section for the value x′₁ shifted to the center value of the adjacent section is determined as follows.

$$τ = \{ \begin{matrix}0 , if ( {x}^{′} = {R}_{j} and x ∈ {P}_{j - 1} ) or ( {x}^{′} = {R}_{M}^{+} and x ∈ {P}_{1} ) \\ 1 , if ( {x}^{′} = {R}_{i} and x ∈ {P}_{i + 1} ) or ( {x}^{′} = {R}_{1} and x ∈ {P}_{M}^{+} )\end{matrix} \qquad ( 36 )$$

In this way, watermarks are embedded into all code values in the code sequence X without occurrence of intra code and inter code false start codon, and the watermarked non-coding region Γ′(n) is obtained. The additional information required for watermark decoding and restoration of the original code value is the number K of shifting bits for each code value, the marker T of the shifted section, and the LSB bit E of a 2-bit base binary number, like the non-circular method. LSB substitution of the compressed additional information is applied in the same manner as the two methods, and the final watermarked DNA sequence D′ by the substituted region Γ″(n) is transmitted.

(2) Decoding and Restoration Processes

Form the substituted region Γ″(n) of the transmitted DNA sequence, the watermarked region Γ′(n) is obtained by inverse substitution, and then from the code sequence X′ in Γ′(n), the watermark is decoded by (K,T) and the original code sequence is restored.

When the code value x′₁ with kᵢ>0 is provided in the code sequence X′, the center value R of the previous section of x′₁ is obtained depending on the boundary section and the non-boundary section as follows.

$$\begin{matrix}R = \{ \begin{matrix}{R}_{j - 1} , if {x}_{i}^{′} ∈ {P}_{j}^{-} or ( {x}_{i}^{′ } = {R}_{j} and {τ}_{i} = 0 ) \\ {R}_{j + 1} , if {x}_{i} ∈ {P}_{i}^{+} or {x}_{i}^{′ } = {R}_{i} and {τ}_{i} = 1 for non \text{-} boundary region\end{matrix} & ( 37 ) \\ R = \{ \begin{matrix}{R}_{M}^{+} , if 0 ≦ {x}_{i}^{′} < {R}_{1} or {x}_{i}^{′ } = {R}_{1} and {τ}_{i} = 0 \\ {R}_{1} , if {R}_{M}^{+} < {x}_{i}^{′ } ≦ {2}^{{2}_{n} - 1} or {x}_{i}^{′} = {R}_{M}^{+} and {b}_{i} = 1 \\ for boundary region\end{matrix} & ( 38 )\end{matrix}$$

k₁ bits {w_{I}}_{I=1}^{k}^{_{f}} and the original code value xᵢ are obtained by R as follows.

w_{I}=(((x′ᵢ−R)%2²ⁿ)>>(l−1))%2 for l=1, . . . ,kᵢ (39)

xᵢ=R+((x′ᵢ−R)%2²ⁿ>>kᵢ) (40)

(3) Watermark Capacity and Additional Information

In the circular histogram shifting method, the watermark is embedded in all sections except for the residual section in the code value histogram domain range. Thus, when the coding order and the maximum number kₘₐₓ of section shifting bits are given, the number of watermark bits in the embedding region Γ(n) is the sum of the number of shifting bits on the left subsection Pᵢ⁻ (d<0) and the right subsection Pᵢ⁺ (d>0) of each section, and bpn bpn_{CHS}(n,kₘₐₓ) thereof is as follows.

$${bpn}_{CHS} ( n , {k}_{max} ) = \frac{1}{{\sum }_{i = 1}^{\vert Γ ( n ) \vert} {N}_{i}} {\sum }_{j = 1}^{M} ( C ( {P}_{j}^{+} ) + C ( {P}_{j}^{-} ) ) [ bit ] \qquad ( 41 )$$

The additional information Extra_{HS}(n,kₘₐₓ) for watermark extraction and restoration is the same as information in the non-circular histogram shifting method, Extra_{HS}(n,kₘₐₓ)=Extra_{CHS}(n,kₘₐₓ). Like the above-described methods, lossless compression is performed such that the additional information Extra_{CHS}(n,kₘₐₓ) is

$$ρ \times {Extra}_{CHS} ( n , {k}_{max} ) < Φ ≦ {\sum }_{i = 1}^{\vert Γ ( n ) \vert} \vert {D}_{i} \vert .$$

The circular histogram shifting method has the same additional information but higher watermark capacity, compared to the non-circular histogram shifting method.

The previous region information of the code value shifted to the center value and information on the number of embedded bits of the code value that belong to all regions except for the residual value region are follows.

$${N}_{E}^{CHS} = N \times [ p ( {x}^{′} ϵR ) + ( 1 - {\sum }_{t = {R}_{N} + 1}^{{R}_{N} - 1} p ( t ) ) \times ⌈ {log}_{2} {k}_{max} ⌉ ) ] [ bit ] \qquad ( 42 )$$

Here,

$${\sum }_{t = {R}_{1} + 1}^{{R}_{N} - 1} p ( t )$$

is probability of belonging to the residual value, and ℏ is reference value R={R₁, R₂, . . . , R_{M-1}, R_{M1}, R_{M2}} of the region. Thus, the bpn of additional data is bpn_{E}^{CHS}=N_{E}^{CH}/N_{D} [bit/base]. Capacity efficiency O^{CHS} that is a ratio of additional data to the embedded data is C^{CHS}=N_{W}^{CHS}/N_{E}^{CHS}=bpn_{W}^{CHS}/bpn_{E}^{CHS}.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A reversible DNA information hiding method based on prediction-error expansion and histogram shifting, the method comprising:
coding, at a first step, a four-letter base sequence of a non-coding region DNA to an n order code value;
embedding, at a second step, multiple bits for each code value by a least square (LS) prediction error;
embedding, at a third step, an n order watermark bit by non-circular histogram and circular histogram multi-level shifting;
verifying, at a fourth step, occurrence of a start code of a watermarked intra code value and a watermarked inter code value.

2. The method of claim 1, wherein at the first step,
b is a four-letter base b={‘A’, ‘T’, ‘C’, ‘G’}, b is a base value of the b, x is a base block consisting of n bases, x is a code value for the base block x, and n is a coding order,
coding to a 2n-bit code value x in units of the base block x consisting of the n bases is performed as follows
$$x = f ( x ) = {\sum }_{k = 1}^{n} ( {b}_{k} \cdot {2}^{2 ( n - k )} )$$
where x=(b₁, b₂, . . . , bₙ), x∈┌0,2²ⁿ−1┐ and
The bases of the base block are restored from the code value x as follows
f⁻¹(x)=x where bₖ=(x>>2(n−k))%4 for k=1, . . . , n.

3. The method of claim 1, wherein at the fourth step, preventing of a false start codon in the watermarked intra code value comprises:
generating a code value table containing the false start codon in advance; and
embedding a watermarked code value not to contained in the code value table.

4. The method of claim 1, wherein at the fourth step, preventing of a false start codon in the watermarked intra code value comprises:
when a previous watermarked code value x′₁₋₁ is given, a number of embedded bits for a current processed code value x′₁ is controlled such that the current processed code value x′₁ does not satisfy
x′₁₋₁(n−1,n)∥x′₁(1,2)∈Z^{c}
if (x′₁₋₁%2⁴)=f(‘AT’)=1 and (x′₁>>2(n−1))%2²=f(‘G’)=3
if (x′₁₋₁%2²)=f(‘A’)=0 and (x′₁>>2(n−2))%2⁴=f(‘YG’)=7.

5. The method of claim 1, wherein at the second step, the code value is predicted through local prediction for each embedding region.
